(19) United States
(12) Patent Application Publication
(10) Pub. No.: US 2025/0152470 A1
(43) Pub. Date: May 15, 2025

(54) MODULAR FRAME STRUCTURE

(71) Applicant: Infinitree Inc., Oakville (CA)

(72) Inventors: DOUGLAS DARBY, Freelton (CA); GEORGE FUNG, Maple (CA); VANJA CECEN, East York (CA)

(73) Assignee: Infinitree Inc., Oakville (CA)

(21) Appl. No.: 18/943,726

(22) Filed: Nov. 11, 2024

Related U.S. Application Data
(60) Provisional application No. 63/597,688, filed on Nov. 9, 2023.

(51) Int. Cl. A61H 33/00; F16B 2/22

(52) U.S. Cl. CPC A61H 33/6005; F16B 2/22; A61H 2201/0107

(57) ABSTRACT

Apparatuses, methods, and systems are disclosed for a modular frame structure. An apparatus includes a base member and at least one locking structure coupled to the base member, the at least one locking structure comprising at least one locking arm and a locking element coupled to the locking arm. The at least one locking structure is configured to be inserted into a support member to couple the apparatus to the support member.

### CROSS-REFERENCE TO RELATED APPLICATIONS

This application claims the benefit of Provisional Patent Application No. 63/597,688 entitled MODULAR FRAME STRUCTURE and filed on Nov. 9, 2023, for Douglas Darby et al., which is incorporated herein by reference.

### FIELD

The subject matter herein relates to frames and more particularly relates to a modular frame structure.

### BACKGROUND

A hot tub is a large tub full of water used for hydrotherapy, relaxation or pleasure. Some have powerful jets for massage purposes. Hot tubs are sometimes also known as “spas” or by the trade name Jacuzzi. Hot tubs may be located outdoors or indoors and may come in various sizes to accommodate different numbers of people.

### SUMMARY

Apparatuses, methods, and systems are disclosed for a modular frame structure. In one embodiment, an apparatus includes a base member and at least one locking structure coupled to the base member, the at least one locking structure comprising at least one locking arm and a locking element coupled to the locking arm. In one embodiment, the at least one locking structure is configured to be inserted into a support member to couple the apparatus to the support member.

In one embodiment, a system includes a connector comprising a base member and at least one locking structure coupled to the base member, the at least one locking structure comprising at least one locking arm and a locking element coupled to the locking arm. In one embodiment, the system includes a support member comprising at least one opening for receiving the at least one locking structure to couple the connector to the support member.

In one embodiment, a frame includes a plurality of connectors that each includes a base member and at least one locking structure coupled to the base member, the at least one locking structure comprising at least one locking arm and a locking element coupled to the locking arm. The frame, in one embodiment, includes a plurality of support members where each support member includes at least one opening for receiving the at least one locking structure to couple the connector to the support member and a channel that runs along at least a portion of the support member, the channel configured to receive a corresponding insertion member. In one embodiment, the system includes a plurality of cladding members configured to attach to the plurality of support members via the channel and a plurality of kick rail members coupled to bottom support members of the frame.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A depicts an exploded view of a modular frame structure, in accordance with the subject matter described herein.

FIG. 1B depicts an assembled view of a modular frame structure, in accordance with the subject matter described herein.

FIG. 1C depicts an assembled view of a modular frame structure with attached cladding and corner pieces, in accordance with the subject matter described herein.

FIG. 2A depicts one embodiment of a connector, in accordance with the subject matter described herein.

FIG. 2A-1 depicts one embodiment of a connector, in accordance with the subject matter described herein.

FIG. 2A-2 depicts one embodiment of a connector, in accordance with the subject matter described herein.

FIG. 2A-3 depicts one embodiment of a connector, in accordance with the subject matter described herein.

FIG. 2A-4 depicts one embodiment of a connector, in accordance with the subject matter described herein.

FIG. 2B depicts one embodiment of a three-way connector, in accordance with the subject matter described herein.

FIG. 2C depicts one embodiment of a three-way corner connector, in accordance with the subject matter described herein.

FIG. 2D depicts one embodiment of another three-way corner connector, in accordance with the subject matter described herein.

FIG. 2F depicts one embodiment of a locking element, in accordance with the subject matter described herein.

FIG. 2G depicts one embodiment of a locking element, in accordance with the subject matter described herein.

FIG. 3A depicts one embodiment of a support member, in accordance with the subject matter described herein.

FIG. 3B depicts one embodiment of a cross-section of a support member, in accordance with the subject matter described herein.

FIG. 4 depicts one embodiment of a connector being inserted into and connected to a support member, in accordance with the subject matter described herein.

FIG. 5 depicts securing a connector to a support member, in accordance with the subject matter described herein.

FIG. 6A depicts one embodiment of a snap-in receiver connector that is inserted into the channel of the support member, in accordance with the subject matter described herein.

FIG. 6B depicts a t-snap connector inserted into a snap-in receiver connector, in accordance with the subject matter described herein.

FIG. 6C depicts one embodiment of the mushroom-shaped connector of a corner component, in accordance with the subject matter described herein.

FIG. 6D depicts one embodiment of a corner component connected to support members, in accordance with the subject matter described herein.

FIG. 6E depicts one embodiment of a slide-in connector, in accordance with the subject matter described herein.

FIG. 7A depicts one embodiment of a mounting panel hook connector, in accordance with the subject matter described herein.

FIG. 7B depicts one embodiment of a mounting panel hook connector connected to a support member and cladding panel, in accordance with the subject matter described herein.

FIG. 7C depicts one embodiment of a modular frame system with cladding panels installed, in accordance with the subject matter described herein.

FIG. 8A depicts one embodiment of a cleat connector, in accordance with the subject matter described herein.

FIG. 8B depicts one embodiment of a cladding panel connected to a frame via a cleat connector, in accordance with the subject matter described herein.

FIG. 9A depicts one embodiment of a vertical cross support member, in accordance with the subject matter described herein.

FIG. 9B depicts one embodiment of a vertical cross support member installed between two support members, in accordance with the subject matter described herein.

FIG. 9C depicts one embodiment of a horizontal cross support member, in accordance with the subject matter described herein.

FIG. 9D depicts one embodiment of a horizontal cross support member installed between two support members, in accordance with the subject matter described herein.

FIG. 10A depicts one embodiment of a kick rail, in accordance with the subject matter described herein.

FIG. 10B depicts one embodiment of a kick rail, in accordance with the subject matter described herein.

FIG. 10C depicts one embodiment of a kick rail, in accordance with the subject matter described herein.

FIG. 10D depicts one embodiment of a kick rail, in accordance with the subject matter described herein.

FIG. 10E depicts one embodiment of a kick rail, in accordance with the subject matter described herein.

FIG. 11 depicts one embodiment of a method, in accordance with the subject matter described herein.

### DETAILED DESCRIPTION

The subject matter herein relates to frames and more particularly relates to a modular frame structure, such as a spa or hot tub frame. The modular frame structure herein is easy to assemble and provides significant improvements and savings in the hot tub manufacturing process compared to the current industry standard of using wooden hot tub frames. The modular frame structure also improves the efficiency of installing cladding panels and various equipment, as well as providing increased longevity of the product for the customer.

In one embodiment, the modular frame structure described herein includes a plurality of thermoplastic pieces that can be customized and assembled to form a frame, e.g., a spa/hot tub frame assembly system, designed to replace wood in conventional spa/hot tub frames. In contrast to the manufacturing of conventional wooden hot tub frames, which requires significant labor, equipment, and space for all of the necessary operations of cutting, routing, screwing, and nailing wood, the modular frame structure described herein can be assembled without power tools in a fraction of the time and space that a traditional wood frame would require. In addition to its efficient and easy assembly, thermoplastic components used for the modular frame structure described herein provide exceptional dimensional stability that provides a higher quality in assembly of cladding panels, corners, and various equipment onto hot tubs. The modular frame structure design also provides innovative panel attachment features that do not require screws or other fasteners, which solves the common expansion and contraction issues that are prevalent in the industry.

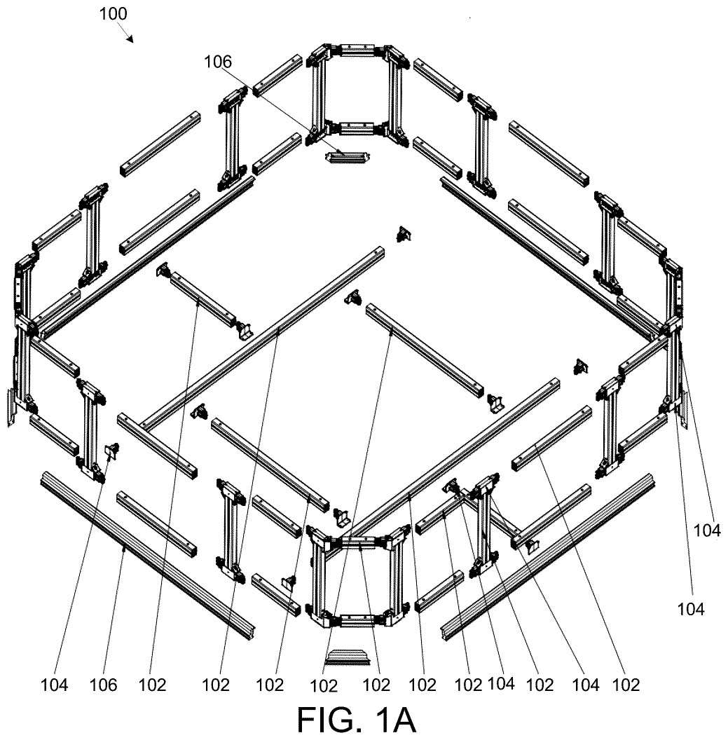

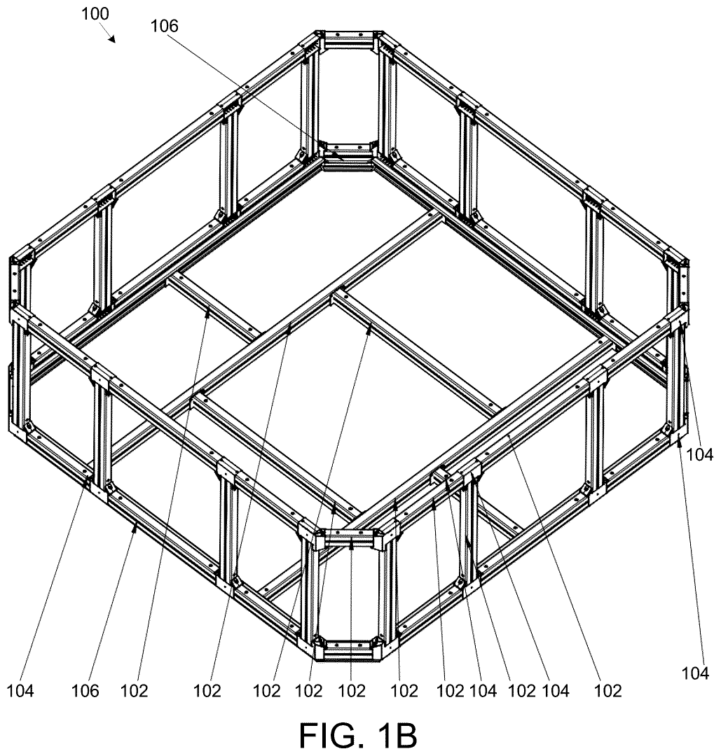

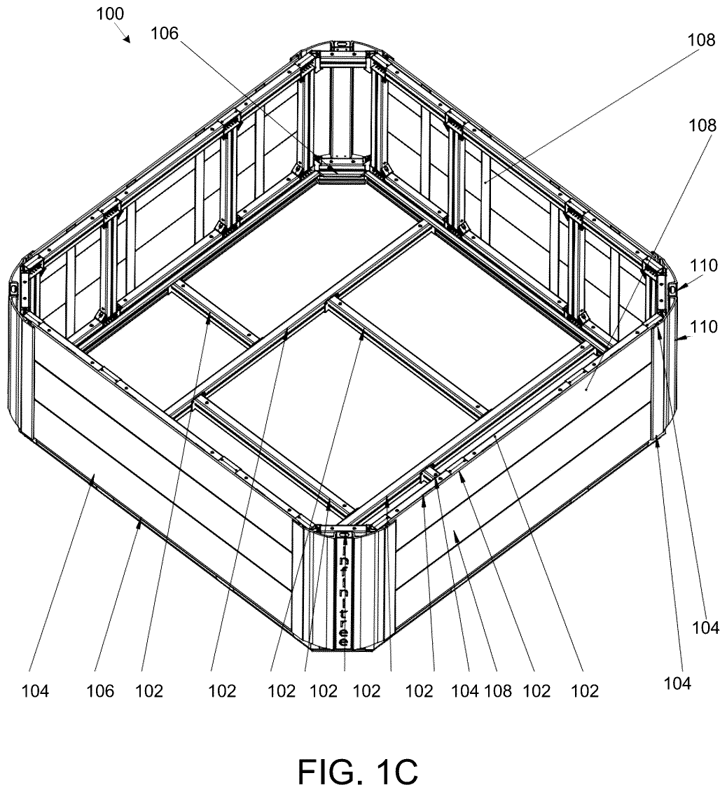

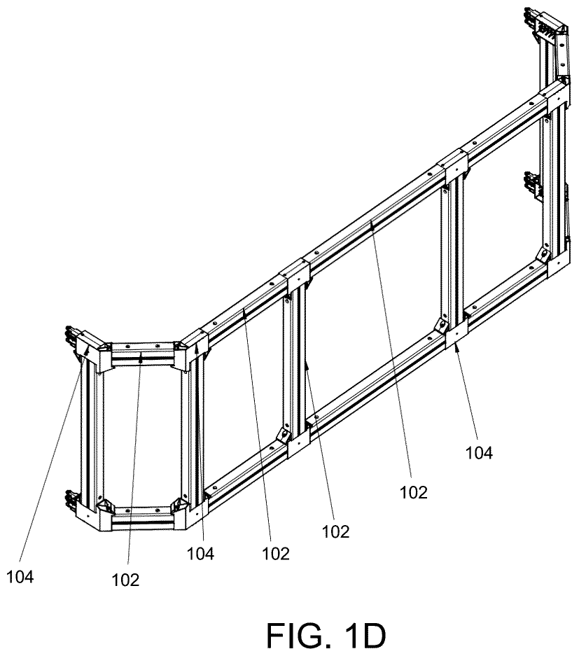

FIG. 1A depicts an exploded view of a modular frame 100, as described herein. In one embodiment, the modular frame 100 includes a plurality of support members 102, a plurality of connectors 104, and a kick rail 106. The support members 102 may be customized, cut or otherwise sized to a particular length, thickness, width, or the like, and may be oriented horizontally, vertically, diagonally, or the like.

The connectors 104 may be configured to connect support members 102 together to form the modular frame 100. The connectors 104 may be of different types such as a t-connector, a three-way connector, a corner connector, and/or the like. As described in more detail below, the connectors 104 include locking elements that secure a connector 104 to a support member 102 and ultimately interlock the support members 102 together to form the modular frame 100. In one embodiment, the kick rail 106 may be configured to connect to a bottom of the modular frame 100 and prevent moisture and debris from entering the modular frame 100, while also facilitating manual lifting and repositioning of the frame 100.

FIG. 1B depicts an assembled view of a modular frame 100, as described herein. In one embodiment, the support members 102 are connected together to form the modular frame 100 using various interlocking connectors 104, as described in more detail below. In one embodiment, the modular frame 100 supports frame structures of various sizes, dimensions, configurations, shapes, or the like based on the arrangement, types, lengths, and sizes of support members 102.

FIG. 1C depicts an assembled view of a modular frame structure with attached cladding, including side panels 108 and corner panels 110. The modular frame system 100 described herein allows for screwless assembly of cladding panels and corners, by inserting or connecting the cladding 108, 110 to grooves, slots, channels, or the like in the support members 102, described below.

FIG. 1D depicts an assembled view of a corner and side portion of a modular frame structure. As shown in FIG. 1D corner connectors 104, e.g., connectors 104 with angled base members, may be used to connect support members 102 and create the corner portions of the frame 100.

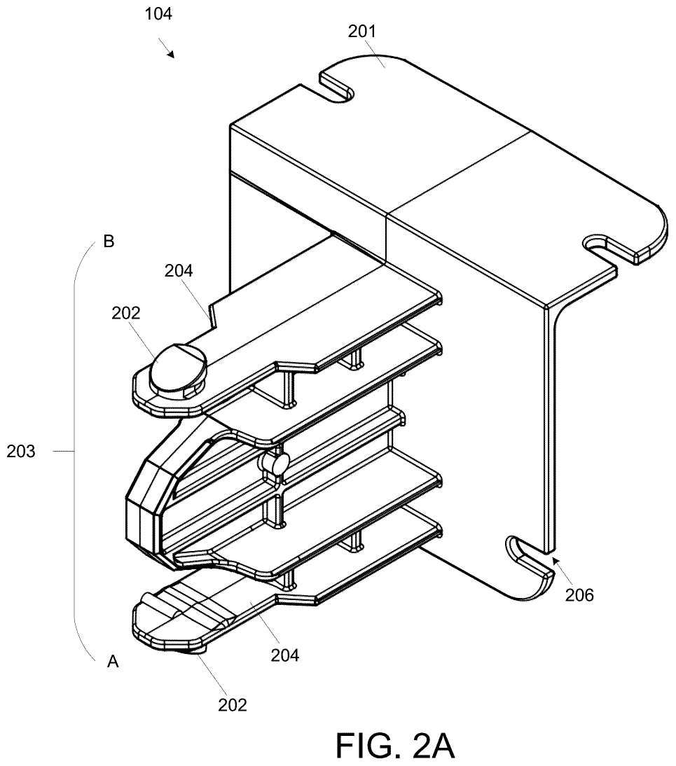

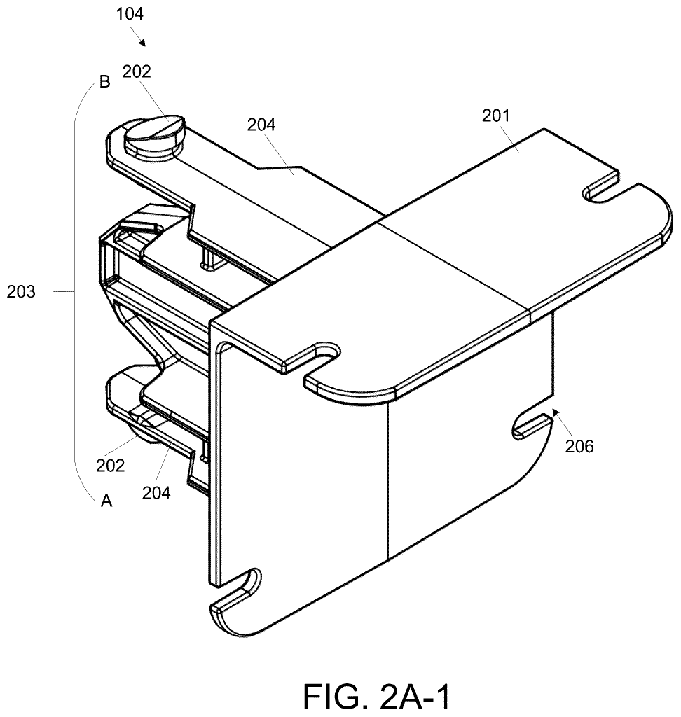

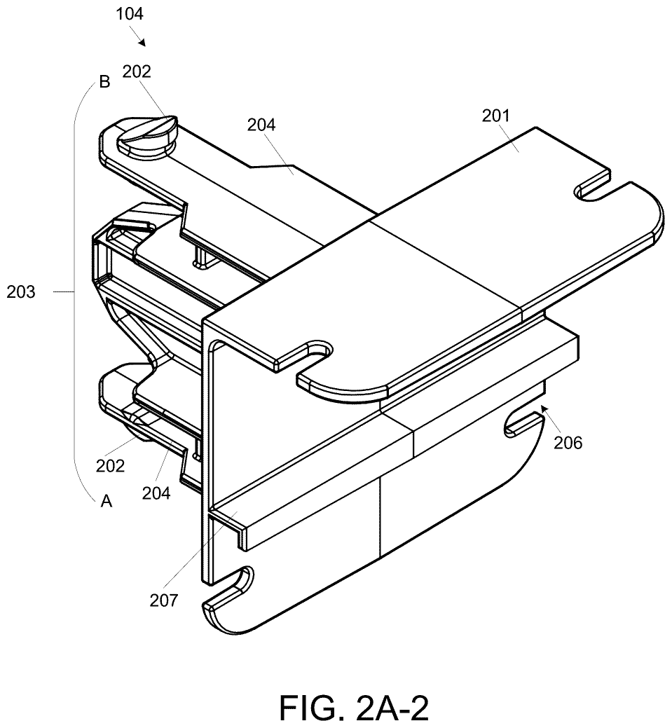

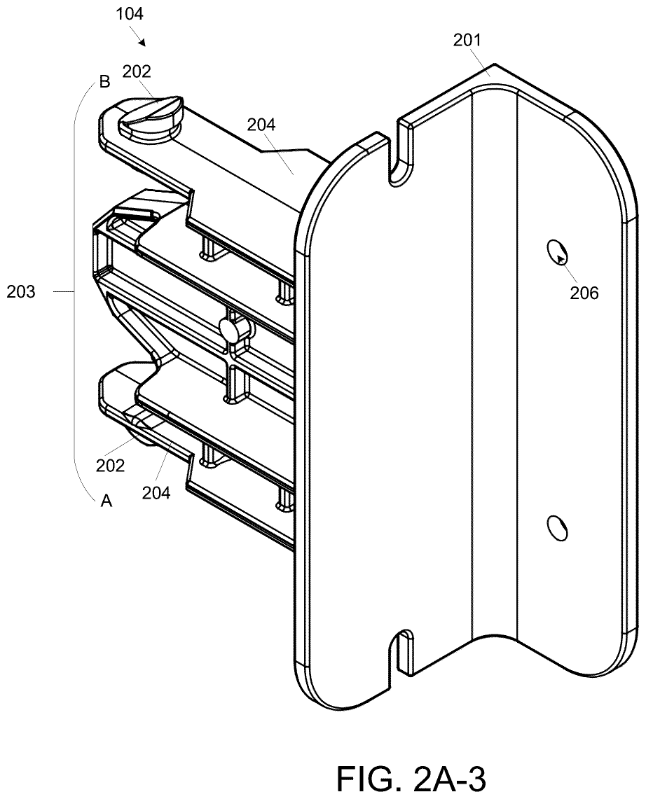

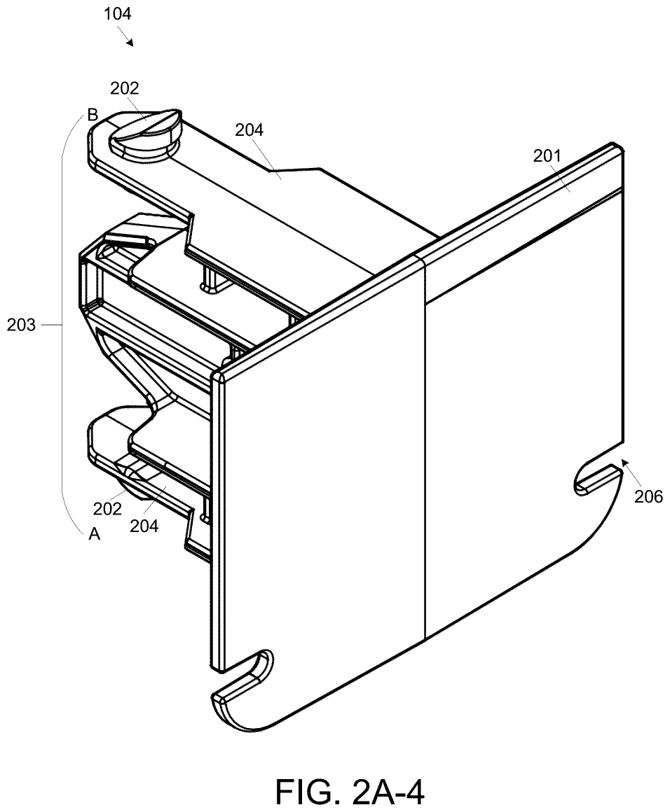

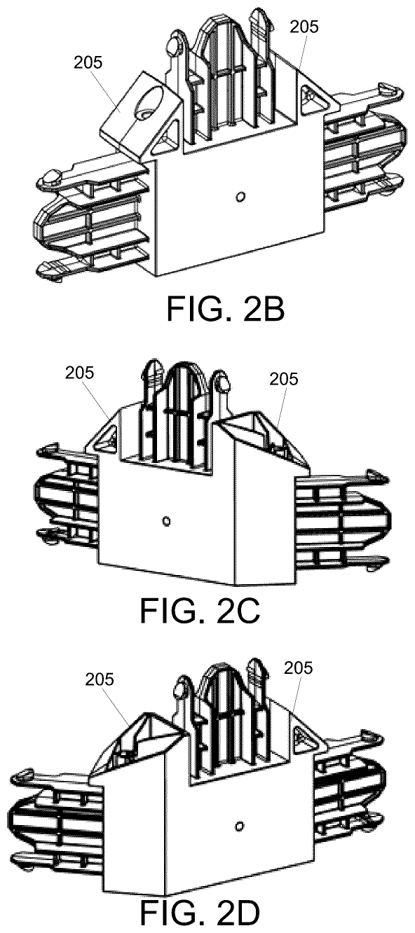

In one embodiment, the modular frame 100 disclosed herein consists of support members 102 that have a hollow extrusion frame profile and a plurality of different connectors 104 to connect the support members 102 together. FIGS. 2A-2D depict the different connectors that may be used to connect the structure elements. In one embodiment, each of the connectors is used in a specific way to connect with the hollow frame profile extrusions.

FIG. 2A depicts one embodiment of a connector 104, in particular, a t-connector. The connector 104, in one embodiment, includes a base member 201, base plate, or the like. The base member 201 may be the structural foundation of the connectors 104a-d and may have a thickness, width, length, or other dimensions that is rated to support a predefined weight, stress, force, or the like.

In one embodiment, the connector 104 includes at least one locking structure 203 that is coupled to the base member 201. In one embodiment, the locking structure 203 is oriented perpendicular to the base member 201, as shown in FIG. 2A. In some embodiments, the locking structure 203 may be oriented parallel to or in line with the base member 201, e.g., the locking structure 203 may be connected to an edge or side of the base member 201, as shown in FIGS. 2A-2C. For instance, the connector 104 may include two locking structures 203 coupled to opposite edges of the base member 201, which would be configured to connect two support structures together in line. In another embodiment, the connector 104 may include three locking structures 203 coupled to three edges of the base member 201, two edges and a surface of the base member 201, two surfaces and one edge of the base member 201, or the like. Other configurations may include four locking structures 203, five locking structures 203, six locking structures (e.g., all edges and surfaces of the base member 201), or the like.

The locking structure 203 may include different locking and structural elements that are configured to securely connect to a support member 102. For instance, the locking structure 203 may include a locking arm 204 that includes a locking element 202 coupled to the locking arm 204. In one embodiment, the connector 104 may include a single locking arm 204, or may include a plurality of locking arms 204, such as those shown in FIG. 2A. In one embodiment, the locking arm 204 is flexible such that the locking arm 204 bends when inserted into a support member 102.

In one embodiment, the locking element 202 is shaped and sized to match a corresponding locking receiving member, e.g., an opening or hole, in a support member 102, described in more detail below. For example, the locking element 202 may have a cylindrical shape, but other shapes may be envisioned such as square, triangular, star, or the like.

In one embodiment, a width of the locking structure 203, e.g., the length from A to B shown in FIG. 2A, is (slightly) wider than an opening in the support member 102 such that when the locking structure 203 is inserted into the opening in the support member 102, the locking arms 204 are squeezed creating resistance that provides additional compression to help secure the locking structure 203 to the support member 102.

In one embodiment, the base member 201 includes openings 206, holes, or slots for using other attachment or fastening means to secure the base member 201 to another structure. The fastening means may include screws, bolts, rivets, snaps, or other fasteners.

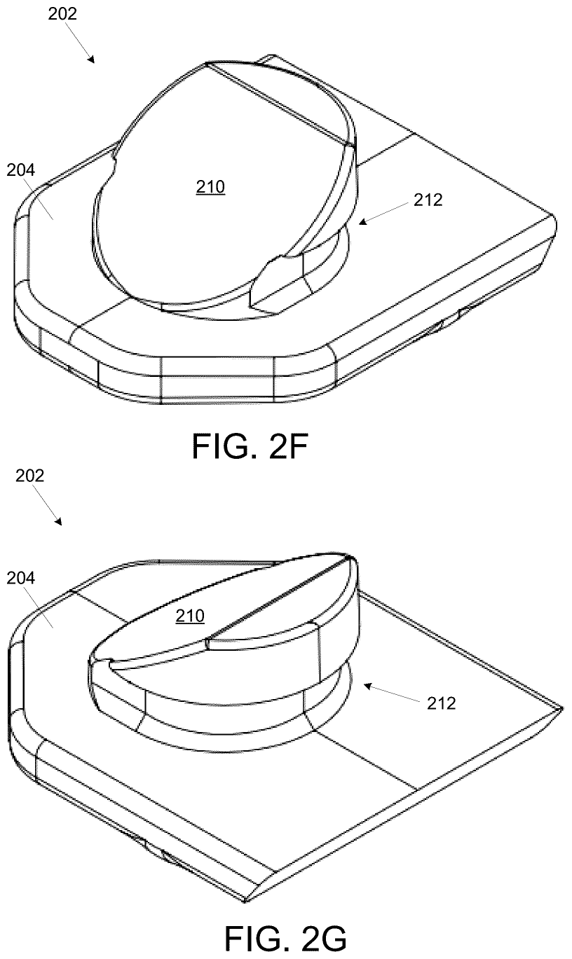

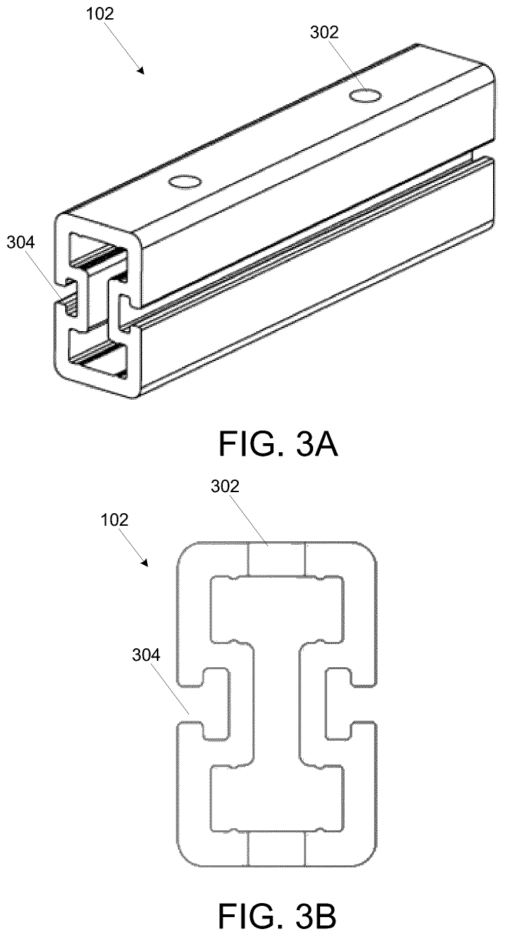

FIG. 2A-1 depicts another perspective view of the connector 104 shown in FIG. 2A. FIG. 2A-2 depicts another embodiment of a connector 104 that includes a clip 207, hook, or the like that acts as an additional securing element when the body 201 is attached to a structure. In such an embodiment, the clip 207 may mate with a corresponding groove or slot to further hold the connector 104 in place. FIG. 2A-3 depicts one embodiment of the connector 104 that has a corner-shaped body 201. FIG. 2A-4 depicts one embodiment of the connector 104 that has a flat body 201 without a flange, clip, or other protrusion.

FIGS. 2B-2D depicts different types of connectors 104. FIG. 2B depicts one embodiment of a three-way connector. FIG. 2C depicts one embodiment of a three-way corner connector that includes an angled base (e.g., a 45-degree connector, a 60-degree connector, a 90-degree connector, or the like). FIG. 2D depicts one embodiment of another angled three-way corner connector (with the angled portion on the opposite end). In the three-way connectors shown in FIGS. 2B-2D, the connector 104 includes a brace structure 205 that is located between two of the locking structures and configured to provide further support to the two locking structures 203.

FIGS. 2F-2G depict one embodiment of a locking element 202. In one embodiment, the locking element 202 has a cylindrical shape and size that corresponds to an opening in the support member 102. When the locking structure 203 is inserted into the support member 102, the locking element 202 is inserted into an opening in the support member 102, which secures the locking structure 203, and ultimately the connector 104, to the support member 102. Such an embodiment is the primary securing mechanism between the connector 104 and the support member 102.

In further embodiments, the locking element 202 comprises a secondary locking element to further secure the locking element 202 in the opening in the support member 102. In such an embodiment, the secondary locking element comprises a slot 212 that is configured to receive an edge of the opening in the support member 102, as described in more detail below. In one embodiment, the slot 212 is designed to provide and maintain the connection between the connector 104 and the support member 102 while supporting high concentrated loads that could cause deflection within the assembly of connectors 104 or the connectors' arms 204 when locked in the support member 102 and ultimately the frame 100.

The slot 212 enables the connector 104 to hook or grab onto the bottom edge of the lock opening 302 in the support member 102 in the event that the frame profile is subjected to high concentrated loads that may cause deflection of the thermoplastic material of the frame 100. This secondary locking element, in one embodiment, further prevents the connector 104 from slipping out of the support member 102.

FIG. 3A depicts one embodiment of a support member 102. In one embodiment, the support member 102 includes a hollow extrusion frame profile that is cut to various lengths for specific positions in the frame. In addition to their precise lengths, each support member comprises lock openings/holes 302, e.g., computer numerical control (CNC)-fabricated holes that allow a support member 102 to connect to a connector 104, e.g., from one end or both ends.

In one embodiment, the support member 102 includes a channel 304, groove, slot, or the like for inserting or connecting additional connectors or other components, e.g., cladding 108. The channel 304 may be a t-shaped channel configured to interlock other components to the support member 102 that have corresponding t-shaped connectors.

FIG. 3B depicts one embodiment of a cross-section of a support member 102. In one embodiment, the support members 102 can be customized by length, width, thickness, depth, and/or the like to create frames 100 of varying dimensions, sizes, configurations, and/or the like, using the connectors 104, e.g., for different sizes and shapes of hot tubs/spas. By varying the frame extrusion profile length that connects left and right corner connectors, the frame assembly can accommodate any spa cladding corner radius.

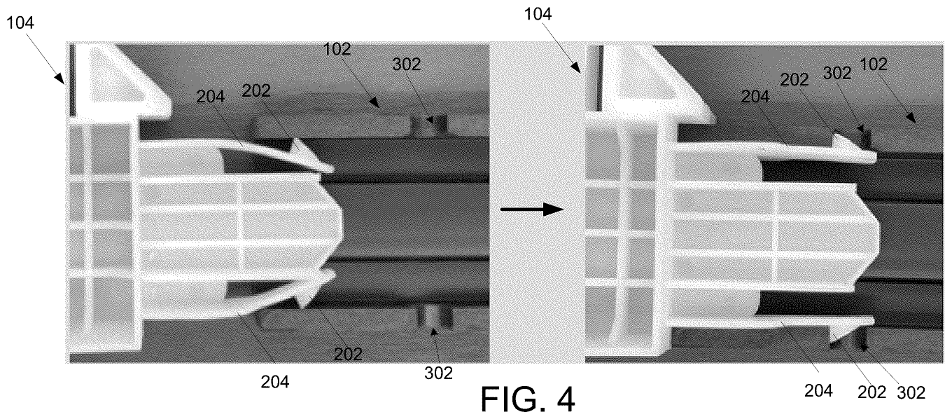

FIG. 4 depicts one embodiment of a connector 104 being inserted into and connected to a support member 102. In such an embodiment, the locking structure 203 is inserted into the support member 102 such that the locking arms 202 flex or bend (because the locking structure 203 is slightly wider than the opening in the support member 102) to fit into the support member 102.

While applying pressure to insert the locking structure 203 into the support member 102, the locking element 202 is inserted into a lock opening 302 in the support member 102. The locking element 202, combined with the lock opening 302 on the support member 102, enables primary and secondary lock functions between the connector 104 and the support member 102. It is noted that because the locking structure 203 is slightly wider than that opening of the support member 102, it provides additional compression to tightly lock the connector 104 to the support member 102.

In one embodiment, insertion of the connector 104 into the support member 102 shown in FIG. 4, enables firm connection of the extrusion and connectors in the installation stage. The connector 104 includes flexible arms 204 or fins with locking elements 202 such that when the connector 104 is pushed or inserted into the hollow portion of the support member 102, the arms 204 that include the locking elements 202 will flex inwards. When the connector 104 is fully inserted into the support member 102, the locking elements 202 spring or snap into the lock openings 302 on the support member 102, locking the connector 104 in place and securing the connector 104 to the support member 102.

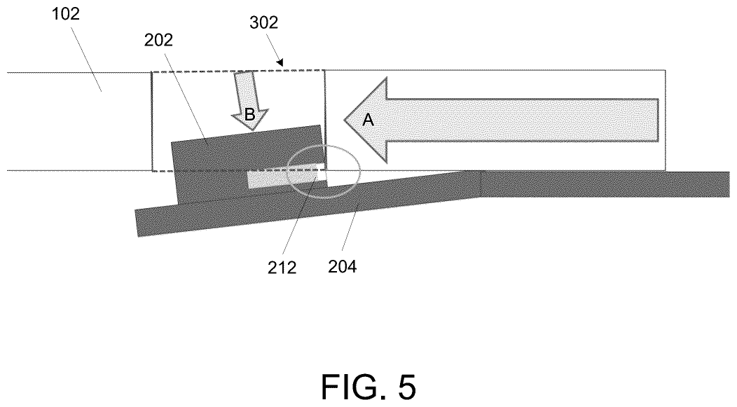

FIG. 5 depicts a schematic that shows the mechanics for connecting a connector 104 to a support member 102. In one embodiment, the locking structure 203 is inserted into the support member 102 in direction A and force is applied until the locking element 202 aligns with the lock opening 302 in the support member 102. In such an embodiment, the arm 204 flexes or bends to allow the locking structure 203 to be inserted into the support member 102. When the locking element 202 is aligned with the lock opening 302 the locking element 202 springs or snaps into the lock opening and secures the locking element 202 within the lock opening 302. The protrusion of the lock element 202 within the lock opening 302, and the force of the arm 204 against the support member 102, secures the connector 104 in place.

In one embodiment, when a down force B is applied, it may cause the locking element 202 to move within the lock opening 302. To prevent the locking element 202 from being dislodged from the lock opening 302, the slot 212 of the lock element 202 connects with, contacts, grabs, or otherwise is secured to a bottom edge of the lock opening 302. In this manner, the connector 104 stays coupled to the support member 102 even when external forces are applied to the frame 100, or the support members 102 of the frame 100.

In one embodiment, the connectors 104 and/or the support members 102 are manufactured of a thermoplastic material. Such materials allow for secure locking of the components and make the frame 100 capable of withstanding structural loads during manufacturing, testing, storage, transport, and final use. The material formulations, in one embodiment, are inseparable variables of the modular frame structure system assembly and its performance. For instance, in one embodiment, the connectors 104 are designed and developed with glass-reinforced Nylon, which provides the required strength, elasticity, and impact resistance to lock into the extrusion frame profile. In one embodiment, the support members 102 are made of a material formula that consists of recycled Polyolefin thermoplastics, two types of fillers, coupling agents, and processing additives.

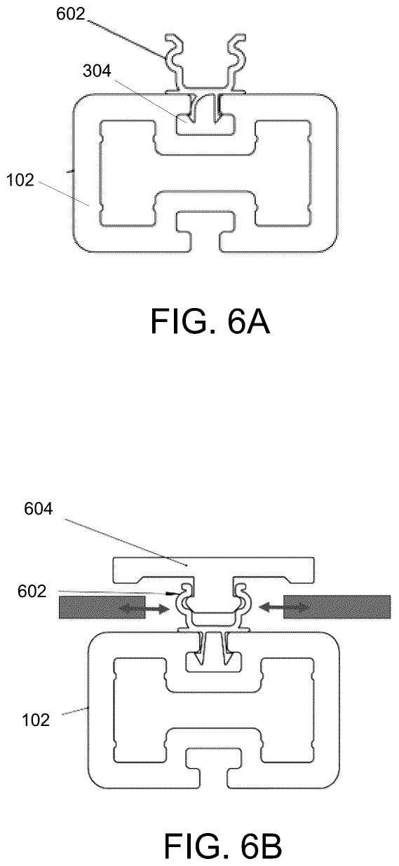

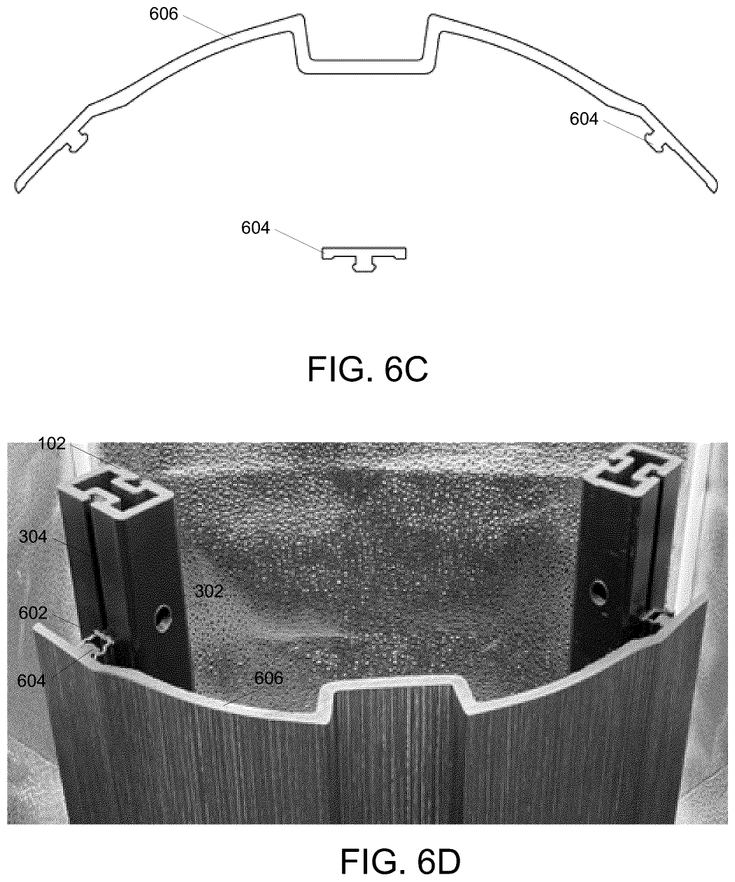

FIG. 6A depicts one embodiment of a snap-in receiver connector 602 that is inserted into the channel 304 of the support member 102. In such an embodiment, the channel 304 in the support member 102 may be utilized for screwless snap-in connections. The snap-in connector 602 shown in FIG. 6A is a receiver connector that enables other components such as corner pieces 110, cladding 108, or the like to be installed without screws, which provides a very convenient method of removing the component in the event of maintenance or repair.

FIG. 6B depicts a t-snap connector 604 of a cladding 108 or corner 110 panel inserted into a snap-in receiver connector 602. As shown in FIG. 6B, in one embodiment, the cladding 108, or other attachable components, may include a corresponding t-snap or mushroom-shaped connector 604 that snaps into the snap-in receiver connector 602.

In one embodiment, the channel 304 in the support member 102 is used in connection with the t-snap or mushroom-shaped connector 604, which allows cladding 108 to freely expand and contract between ends of the connector 604, while the connector 604 hides the ends of the cladding 108.

FIG. 6C depicts one embodiment of the mushroom-shaped connector 604 of a corner cladding component 606 that can be attached to the modular frame structure via the snap-in receiver connector 602.

FIG. 6D depicts one embodiment of a corner cladding component 606 connected to support members 102 via the snap-in receiver 602 and the mushroom-shaped connector 604.

FIG. 6E depicts one embodiment of a slide-in connector 608 that is configured to receive a connector 604 by sliding the connector 604 into the slide-in connector 608. For example, a corner cladding component 606 may include a connector 604 that is configured to slide into the slide-in connector 608.

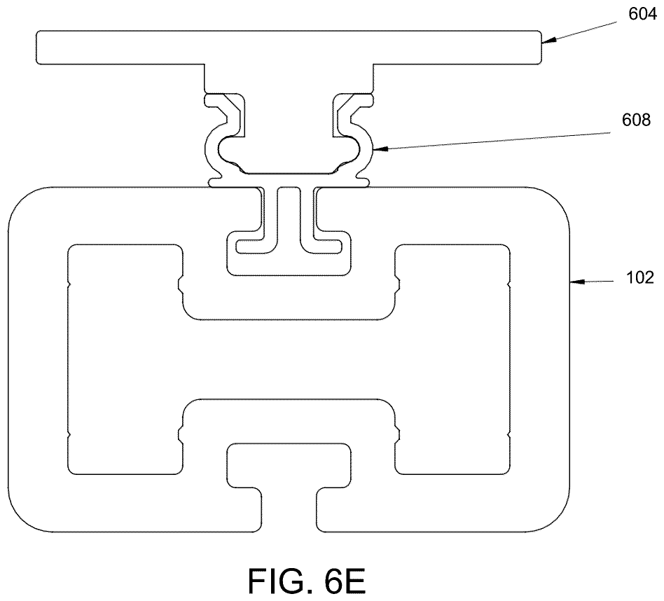

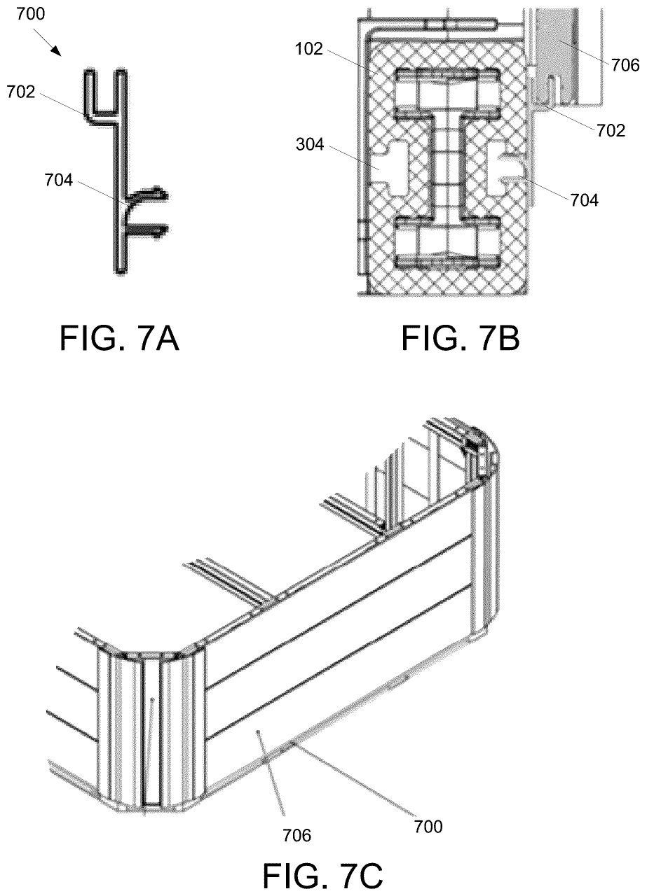

FIG. 7A depicts one embodiment of a mounting panel hook connector 700 that includes a connector 704 that is configured to be inserted or snapped into the channel 304 of the support member 102, without the use of screws or other fastening means. The mounting panel hook connector 700, in one embodiment, also includes a hook member 702 that is configured to receive cladding 108, e.g., a frame panel, or the like.

FIG. 7B depicts one embodiment of a mounting panel hook connector 700 connected to a support member 102. In such an embodiment, the connector 704 is inserted into the channel 304 of the support member 102 to couple the mounting panel hook connector 700 to the support member 102. The cladding panel 706 rests or sits in the hook member 702.

FIG. 7C depicts one embodiment of a modular frame system 100 with cladding panels installed. In such an embodiment, the cladding panel 706 rests or sits in the hook member 702. In such an embodiment, screwless connection of the panel and mounting panel hook enables conflict free expansion and contraction of the spa panel at high and low temperatures.

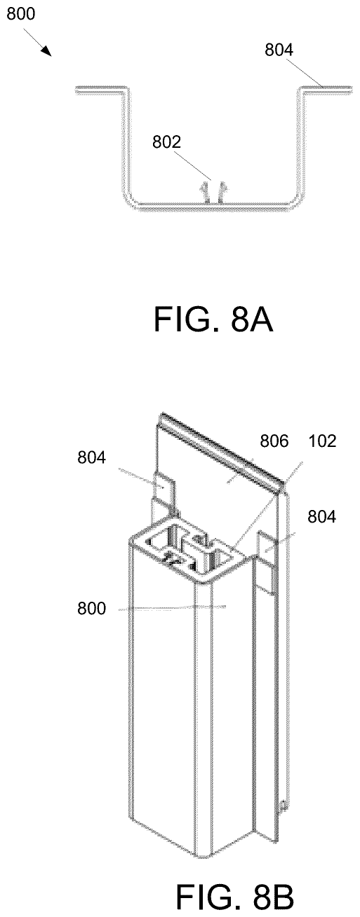

FIG. 8A depicts one embodiment of a cleat connector 800. In one embodiment, the cleat connector 800 includes a connector 802 that couples to the channel 302 in the support member 102.

FIG. 8B depicts one embodiment of a cladding panel 806 connected to a frame via a cleat connector 800. The cleat connector 800 comprises a panel locking feature 804 that keeps a spa cladding panel 806 connected to the frame. If the cladding panel 806 is not connected to the frame, the cladding panel 806 is free to move, and could bow outwards when heated due to exposure to the sun. This bowing occurs because the outer surface of the cladding panel 806 expands more than the inner (hidden) surface. When the cladding panel 806 is connected to the frame, the cleat 800 locks the cladding panel 806 and limits any panel expansion to occur only at the ends of the cladding panel 806. Any expansion and contraction of the cladding panel 806 are hidden under corner ends.

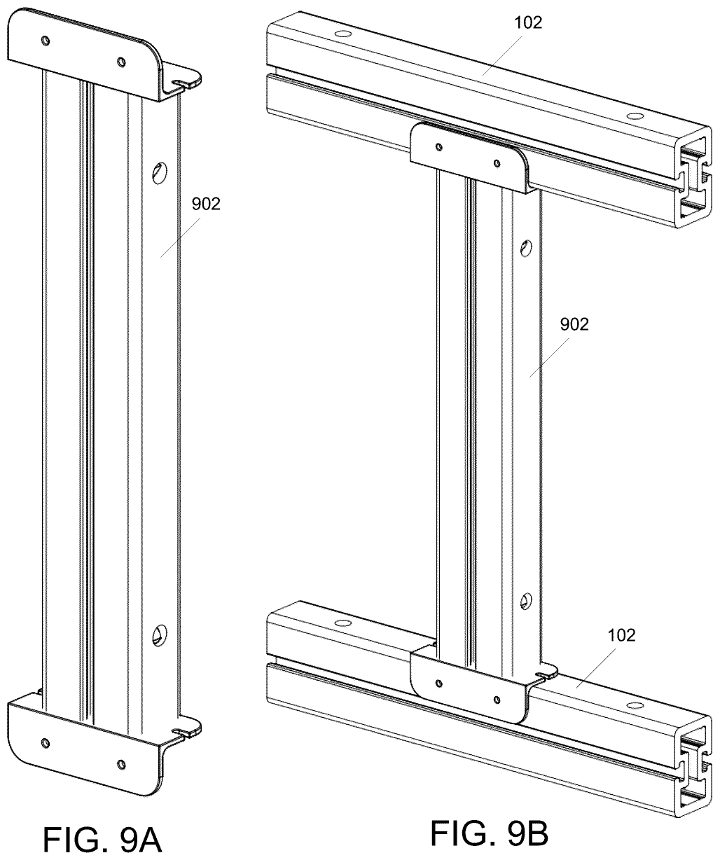

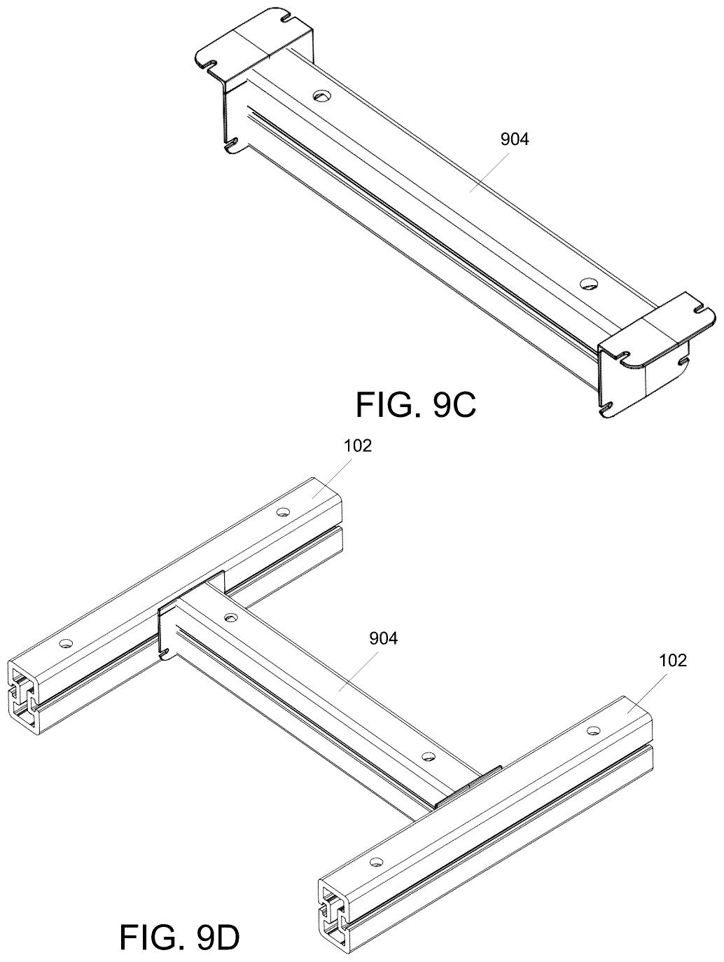

FIGS. 9A-9B depict one embodiment of a vertical cross support member 902, in accordance with the subject matter described herein. In one embodiment, the vertical cross support member 902 is configured to be installed between support members 102 and provide additional strength, as shown in FIG. 9B. In one embodiment, the vertical cross support member 902 may be connected with fasteners such as screws or may be connected using a connector 104 described herein.

FIGS. 9C-9D depict one embodiment of a horizontal cross support member 904, in accordance with the subject matter described herein. In one embodiment, the horizontal cross support member 904 is configured to be installed between support members 102 and provide additional strength, as shown in FIG. 9D. In one embodiment, the horizontal cross support member 904 may be connected with fasteners such as screws or may be connected using a connector 104 described herein.

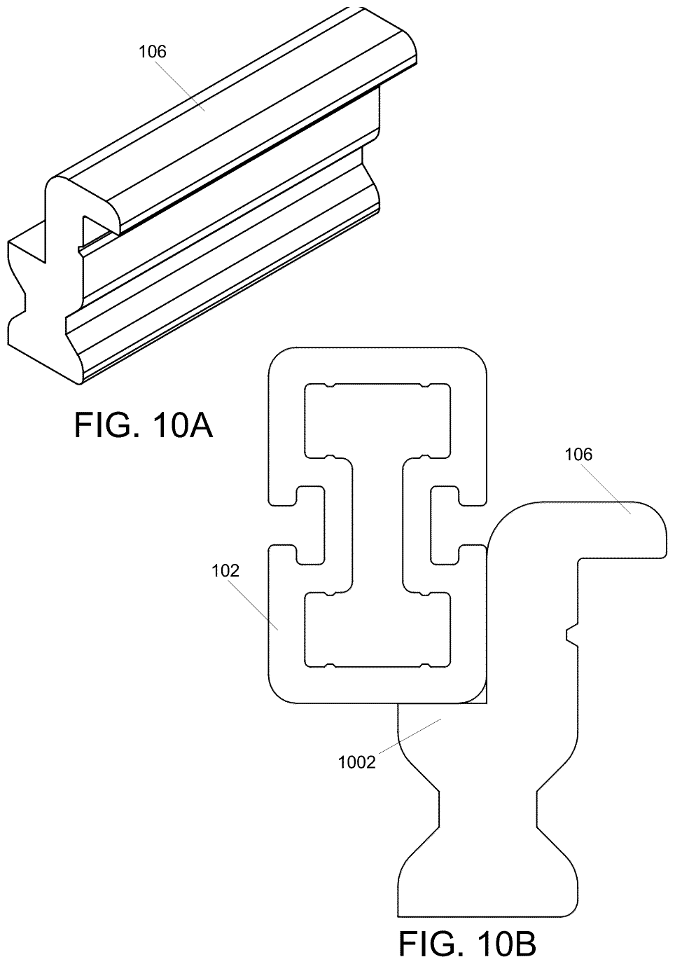

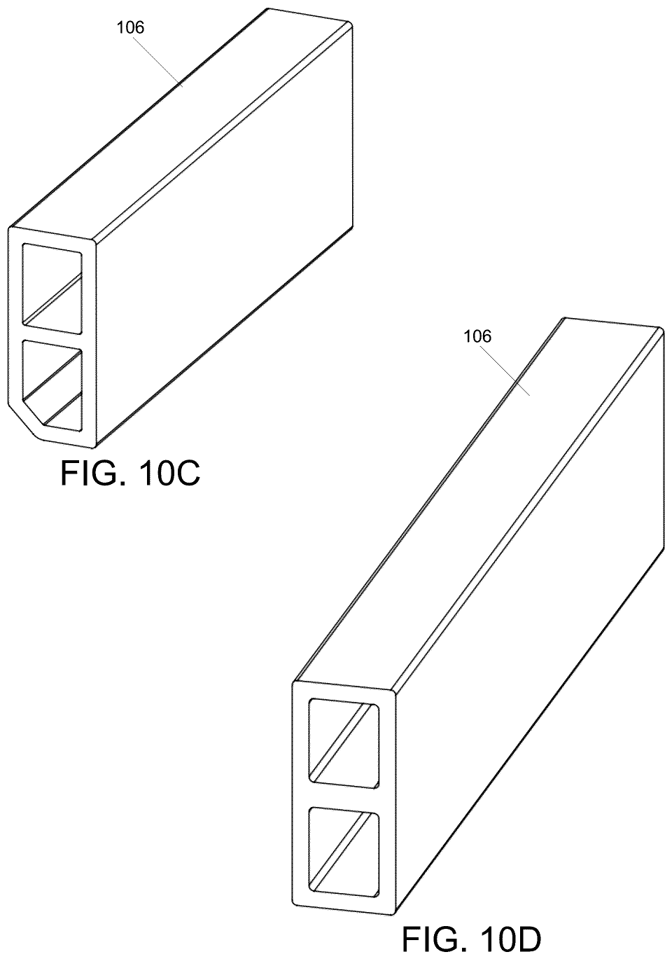

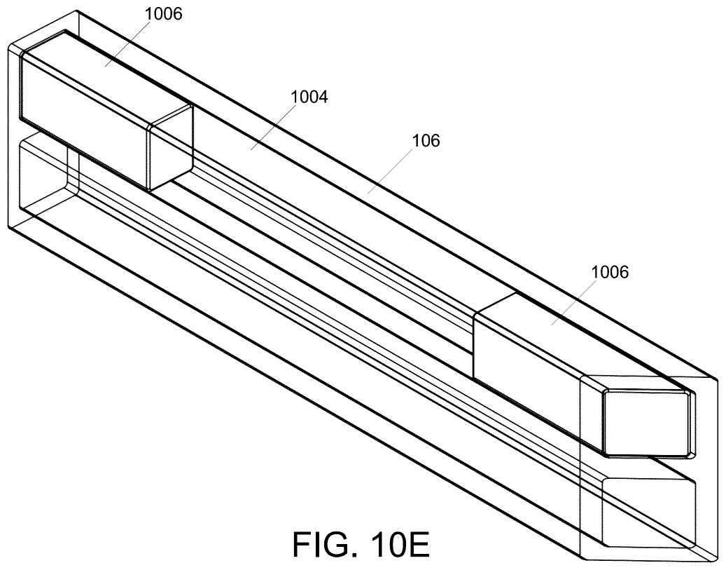

FIG. 10A depicts one embodiment of a kick rail 106, here, a J-shaped kick rail. In one embodiment, the kick rail 106 is installed at the bottom of the frame 100 to set the frame above the ground, to prevent debris/moisture from getting under the frame 100, for decoration, or the like.

FIG. 10B depicts one embodiment of a kick rail 106 installed on a frame. In the depicted embodiment, the support member 102 of the frame 100 sits on a lip 1002 of the kick rail 106. The support member 102 may be attached to the kick rail 106, e.g., using adhesives or fastening means, or may float on the lip 1002. FIGS. 10C-10D depict other embodiments of the kick rail 106.

FIG. 10E depicts one embodiment of a cross section of a kick rail 106. In the depicted embodiment, the kick rail 106 includes one or more hollow channels 1004 running through the kick rail 106. In various embodiments, one or more inserts 1006 may be inserted into the channels 1004 to facilitate connecting the kick rail 106 to the frame 100, e.g., to a support member 102, to another portion of a kick rail 106, or the like. The inserts 1006 may be made of thermoplastic material, wood, metal, or the like. For instance, the inserts 1006 may be inserted into the channels 1004 of the kick rail 106 and fastened to the end of the kick rail 106 (e.g., using screws, nails, or other fasteners), to facilitate connection of the kick rail 106 to the frame 100 (e.g., to the support members 102 and/or connectors 104).

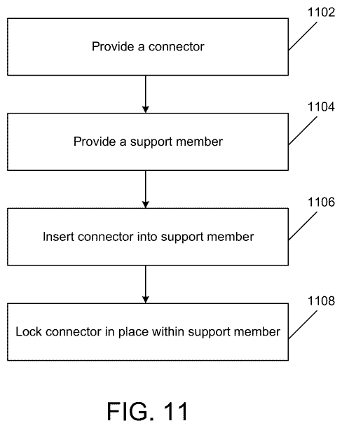

FIG. 11 depicts one embodiment of a method for a frame as described herein. In one embodiment, the method begins and provides 1102 a connector 104, provides 1104 a support member 102, inserts 1106 the connector 104 into the support member 102, and locks 1108 the connector 104 in place within the support member 102, and the method ends.

Apparatuses, methods, and systems are disclosed for a modular frame structure. In one embodiment, an apparatus includes a base member and at least one locking structure coupled to the base member, the at least one locking structure comprising at least one locking arm and a locking element coupled to the locking arm. In one embodiment, the at least one locking structure is configured to be inserted into a support member to couple the apparatus to the support member.

In one embodiment, the at least one locking arm is flexible. In one embodiment, the locking element has a shape and size that corresponds to an opening in the support member. In one embodiment, the locking element comprises a secondary locking element to further secure the locking element in the opening in the support member. In one embodiment, the secondary locking element comprises a slot that is configured to receive an edge of the opening in the support member. In one embodiment, the locking element has a cylindrical shape. In one embodiment, the locking element has a sloped surface for insertion into the opening in the support member.

In one embodiment, the at least one locking structure is wider than an opening in the support member that the support member is inserted into. In one embodiment, the at least one locking structure comprises two locking arms located opposite to each other. In one embodiment, the at least one locking structure is oriented perpendicular to a surface of the base member.

In one embodiment, the apparatus includes two locking structures, each of the two locking structures coupled to opposite edges of the base member. In one embodiment, the apparatus includes three locking structures, each of the three locking structures coupled to three different edges of the base member. In one embodiment, the apparatus includes a brace structure located between two of the locking structures and configured to provide further support to the two locking structures.

In one embodiment, the base member further comprises openings for securing the base member to a different structure using fastening means. In one embodiment, the base member is angled.

In one embodiment, a system includes a connector comprising a base member and at least one locking structure coupled to the base member, the at least one locking structure comprising at least one locking arm and a locking element coupled to the locking arm. In one embodiment, the system includes a support member comprising at least one opening for receiving the at least one locking structure to couple the connector to the support member.

In one embodiment, the support member comprises a lock opening for receiving the locking element. In one embodiment, the support member comprises a channel that runs along at least a portion of the support member, the channel configured to receive a corresponding insertion member. In one embodiment, the channel is a t-shaped channel that is configured to receive a corresponding t-shaped insertion member.

In one embodiment, a frame includes a plurality of connectors that each includes a base member and at least one locking structure coupled to the base member, the at least one locking structure comprising at least one locking arm and a locking element coupled to the locking arm. The frame, in one embodiment, includes a plurality of support members where each support member includes at least one opening for receiving the at least one locking structure to couple the connector to the support member and a channel that runs along at least a portion of the support member, the channel configured to receive a corresponding insertion member. In one embodiment, the system includes a plurality of cladding members configured to attach to the plurality of support members via the channel and a plurality of kick rail members coupled to bottom support members of the frame.

In this manner, the modularity of the frame system allows for efficient and easy hot tub assembly, quality, maintenance, intended use, and longevity. As described above, in various embodiments, the modular frame structure disclosed herein includes primary insert locking mechanism on connectors, secondary locking mechanism on connectors, support members with a hollow profile extrusion, material formulations for the thermoplastic materials, customization of size, shape, and components of the modular frame system, e.g., for various spa manufacturers, screwless installation of corners and cladding panels, snap-in corner and t-snap receiver design, snap in hanging hook or panel mounting hook, vertical cleat panel securing mounting system, increased quality and speed of entire spa/hot tub assembly, elimination or reduction of expansion and contraction issues and warping cladding panel issues typical in the spa/hot tub industry, easy maintenance and service access with screwless corner and cladding panels assembly function, and increased longevity of the spa cladding panels as function of “floating,” screwless spa cladding design as prevention and minimization of warping panels long term deformation typical for the industry. In one embodiment, the frame system provides increased longevity of the based on frame system formulations that do not absorb water that are also not subject to bio attack, which prevents rotting and decay that is typical of wood frames.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a base member; and
at least one locking structure coupled to the base member, the at least one locking structure comprising:
at least one locking arm; and
a locking element coupled to the locking arm,
wherein the at least one locking structure is configured to be inserted into a support member to couple the apparatus to the support member.

2. The apparatus of claim 1, wherein the at least one locking arm is flexible.

3. The apparatus of claim 1, wherein the locking element has a shape and size that corresponds to an opening in the support member.

4. The apparatus of claim 3, wherein the locking element comprises a secondary locking element to further secure the locking element in the opening in the support member.

5. The apparatus of claim 4, wherein the secondary locking element comprises a slot that is configured to receive an edge of the opening in the support member.

6. The apparatus of claim 3, wherein the locking element has a cylindrical shape.

7. The apparatus of claim 3, wherein the locking element has a sloped surface for insertion into the opening in the support member.

8. The apparatus of claim 1, wherein the at least one locking structure is wider than an opening in the support member that the support member is inserted into.

9. The apparatus of claim 1, wherein the at least one locking structure comprises two locking arms located opposite to each other.

10. The apparatus of claim 1, wherein the at least one locking structure is oriented perpendicular to a surface of the base member.

11. The apparatus of claim 1, wherein the apparatus comprises two locking structures, each of the two locking structures coupled to opposite edges of the base member.

12. The apparatus of claim 1, wherein the apparatus comprises three locking structures, each of the three locking structures coupled to three different edges of the base member.

13. The apparatus of claim 12, wherein the apparatus comprises a brace structure located between two of the locking structures and configured to provide further support to the two locking structures.

14. The apparatus of claim 1, wherein the base member further comprises openings for securing the base member to a different structure using fastening means.

15. The apparatus of claim 1, wherein the base member is angled.

16. A system, comprising:
a connector, comprising:
a base member; and
at least one locking structure coupled to the base member, the at least one locking structure comprising:
at least one locking arm; and
a locking element coupled to the locking arm; and
a support member comprising at least one opening for receiving the at least one locking structure to couple the connector to the support member.

17. The system of claim 16, wherein the support member comprises a lock opening for receiving the locking element.

18. The system of claim 16, wherein the support member comprises a channel that runs along at least a portion of the support member, the channel configured to receive a corresponding insertion member.

19. The system of claim 18, wherein the channel is a t-shaped channel that is configured to receive a corresponding t-shaped insertion member.

20. A frame, comprising:
a plurality of connectors, wherein each connector comprises:
a base member; and
at least one locking structure coupled to the base member, the at least one locking structure comprising:
at least one locking arm; and
a locking element coupled to the locking arm;
a plurality of support members, wherein each support member comprises:
at least one opening for receiving the at least one locking structure to couple the connector to the support member; and
a channel that runs along at least a portion of the support member, the channel configured to receive a corresponding insertion member;
a plurality of cladding members configured to attach to the plurality of support members via the channel; and
a plurality of kick rail members coupled to bottom support members of the frame.
